(19) United States
(12) Patent Application Publication
(10) Pub. No.: US 2008/0281658 A1
(43) Pub. Date: Nov. 13, 2008

(54) Systems and methods for creating and reviewing vehicle damage repair estimates, and notifying entities of issues relating to manufacturer's warranty or repair content

(76) Inventor: Steven Siessman, San Diego, CA (US)

Correspondence Address: Steven Siessman, PO 261084, San Diego, CA, 92196, US

(21) Appl. No.: 12/148,737

(22) Filed: Apr. 22, 2008

Related U.S. Application Data
(60) Provisional application No. 60/925,791, filed on Apr. 23, 2007.

(51) Int. Cl. G06Q 10/00; G06Q 50/00; G06F 17/30

(52) U.S. Cl. 705/7; 705/400

(57) ABSTRACT

Methods and systems for generating a damage repair estimate, generating information relating to warranty and short sheet issues for a particular damage repair estimate, identifying included/non-included operations in a target damage repair estimate, and notifying entities of the existence of warranty and short sheet issues. The analysis portion accesses a central database of records for particular vehicles and determines whether a warranty, short sheet, or deviation from pre-determined repair procedures exists and creates a displayable file. Depending on the analysis requested, the system and method displays an appropriate damage estimate analysis. The notification portion accesses a central database of records for particular entities to contact for particular vehicles and electronically notifies entities of the existence of a damage estimate analysis.

### PRIORITY CLAIM

This application claims the benefit of U.S. Provisional Application No. 60/925,791 entitled “SYSTEMS AND METHODS FOR CREATING AND REVIEWING VEHICLE DAMAGE REPAIR ESTIMATES, AND NOTIFYING ENTITIES OF ISSUES RELATING TO MANUFACTURER'S WARRANTY OR REPAIR CONTENT,” filed Apr. 23, 2007

| | |
|---|---|
| CROSS-REFERENCE TO RELATED APPLICATIONS | Not Applicable |
| FEDERALLY SPONSERED RESEARCH | Not Applicable |
| SEQUENCE LISTING OR PROGRAM | Not Applicable |

### BACKGROUND OF THE INVENTION

1. Field of the Invention

The invention relates in general to vehicle damage information systems and in particular, to methods and systems for generating and analyzing damage repair estimates, and notifying entities about estimates that fails to meet pre-determined repair criteria, reduce a manufacturers' warranty, are incomplete or include operations or parts that are duplicated within other operations.

2. Prior Art

Computerized systems for creating damage estimates are known. These systems provide access to large amounts of information for part prices, estimated parts replacement labor times and OEM parts prices. An alternate parts database provides OEM/alternate parts sources and prices. These systems provide for a standardized export format that allows damage estimates to be utilized with communications, auditing and other software systems. Computerized estimating systems are provided by Audatex, CCC Information Services and Mitchell International. U.S. Pat. Nos. 5,432,904 to Wong (1995) and 5,504,674 to Chen, et al (1996) disclose a method for selecting a graphic then individually selecting a part to add to a damage estimate, forcing users to create damage estimates a part or operation at a time. U.S. Pat. No. 6,185,540 to Schreitmueller, et al (2001) discloses a method of “drilling into” layers of a vehicle related to damage zones allowing users to see parts in various related layers and to select a part from a hot spot to add to a damage estimate, again forcing users to select individual parts in layers. U.S. Patent Application 20060064393 to Orr (Sep. 24, 2004) discloses a method for automatically generating vehicles damage estimates. This generation method requires users to manually select a single part or part subgroup and then select the related operation to perform. Only after all parts or parts groups are manually identified by the user can a damage estimate be generated. Generation consists of adding selected parts or subgroups to the estimate, performing arithmetic calculations such as adjusting labor times for overlapping panels, adding non-included operations associated with selected parts or parts groups and calculating the damage estimate total cost.

Computerized systems for auditing damage estimates are known. These systems provide access to business rules such as labor rate rules, parts usage rules, omitted information identification, betterment checking, checking for sales tax and other business rule checking. In addition operational dependencies auditing checks for omitted parts or labor operations. Auditing systems are provided by a variety of companies in the market such as Audatex, CCC Information Services, Mitchell International, Decision Support Services, Newgen IT and others. U.S. Patent Application 20040243423 to Rix, et al (May 30, 2003) discloses a method for identifying related line descriptions and checking a damage estimate for omitted items related to a specific line description. For example, if item “a” is identified in a damage estimate then item “b” should be included in the estimate as well. U.S. Patent Application 20050246206 to Obora, et al (Jun. 13, 2003) discloses a method for comparing a damage estimate against an insurance profile and generating an exception report based on analyzing estimate amounts, property damage limitations, loss limitations or discounts not repair operations. The state of the prior art in damage estimate auditing can best be summarized as identifying parameters that deviate from a profile, such as labor rates or a part type, analyzing damage estimates for deviation from thresholds, such as gross estimate amounts and identifying dependent repair operations.

Computerized systems for interchanging estimating information are known. These systems provide software and a data communications network to send estimate information from a body repair facility or field user to a central system and information from a central system to body repair facility. Administrative information such as insured, policy id, claim id and other information is typically taken by an insurance company on notification of a loss and entered into a first notice of loss system. Information entered in the first notice of loss system can be used in internal claims management systems or downloaded into a computerized estimating system. Downloading administrative information is often the first step in creating a damage estimate. This process is often referred to as receiving an assignment. These systems are used to electronically send estimate supplements from body repair shops to insurance companies. Systems for interchanging estimating information are provided by Audatex, CCC Information Services, Mitchell International, Scene Genesis, Nugen IT, EautoClaims and other companies. In addition some insurance companies build and deploy their own communications networks. U.S. Pat. Nos. 5,504,674 to Chen, et al (1996) and 5,855,005 to Borghesi, et al (1999) disclose a communications network for sending damage estimates from body repair shops to an insurance companies for processing insurance claims.

Computerized systems for providing warranty information are known. These systems are provided by manufacturers and third party service providers. U.S. Patent Application 20040039494 to Kaufman (Sep. 2, 2003) discloses a method for notifying an entity when a vehicle warranty or section of a warranty will expire. U.S. Patent Application 20020091706 to Anderson, et al. (Sep. 6, 2001) discloses a method for a central repository of information vehicle owners can access to retrieve vehicle warranty information. U.S. Pat. No. 6,609,050 to Li (2003) discloses a method for identifying warranty coverage for service repairs and notifying concerned parties when servicing issues have a priority above a predetermined level based on a contact database. U.S. Pat. No. 6,654,770 to Kaufman (2003) discloses a method for providing safety and maintenance information to vehicle owners using the internet.

Computerized diminished value calculation systems are known. Wreck Check provides a 138-plus checkpoint system based on statistical formula, and the consumer's actual repair comparing the pre-accident value of an automobile and the post-repair value of the same automobile. U.S. Pat. No. 6,052,631 to Busch, et al. (2000) discloses a method for detecting the presence of prior damage and problems with previous repairs. U.S. Patent Application 20050038580 to Seim, et al. (Aug. 15, 2003) discloses a method for verifying the structural integrity of vehicle frames allowing dealers to raise the resale value of verified vehicles and support the value of vehicles at auto auctions. The state of the prior art in diminished value reporting can best be summarized as providing information based on measuring dimensions or observing physical damage to a vehicle.

Computerized systems for reporting vehicle history are known. Carfax is the best know company providing an electronic vehicle history report for used vehicles. U.S. Pat. No. 7,113,853 to Hecklinger (2006) and U.S. Patent Application 20060178793 to Hecklinger (Jul. 16, 2003) disclose a method for generating vehicle history related to manufacturer buyback, recall and title status. The state of the prior art in reporting can best be described as providing information based on governmental reporting requirements related to title and accident reporting.

It is common in the industry to write an initial estimate for only damage that is visible and to later supplement the estimate for damage that is discovered during the repair process. This is often referred as short sheeting in the industry. It is not uncommon for an insured to accept a check from their insurance company for visible damage only later to find the initial estimate check significantly under estimated the true cost of repairing the vehicle. Vehicle owners that accept a short sheet from their insurance company and do not repair the vehicle immediately may find significant liability in the difference between the initial damage estimate and the actual amount required to repair the vehicle.

It is common occurrence for a body repair shop to receive an initial damage estimate from an insurance company or independent adjustor that was written using an estimating system they do not use. This leads to a situation where a body repair shop and insurance company utilize two different databases to create and negotiate the damage estimate. Typically body repair shops translate such estimates into estimating systems they have. The situation is complicated by incomplete knowledge of what is included and not included in the varying estimating system line descriptions. It is not uncommon for body repair shops to receive initial short sheets and not be aware of what is included or not included in the repair line descriptions.

Vehicles damaged in accidents may be subject to diminished value. Leased vehicles experience accelerated depreciation related to diminished value by the reduction in the residual value of the vehicle. A lessee can find themselves liable to the bank or leasing company for thousands of dollars in diminished value resulting from a voided or reduced vehicle manufacturer's warranty. Financing companies are at an elevated risk of financial loss associated with diminished value or short sheeting in the event of repossession of vehicles damaged in accidents.

The prior art of damage estimating does not address creating damage estimate using representative vehicle section damage patterns.

The prior art of estimating auditing does not address checking estimates for manufacturer's warranty issues or identifying short sheet estimates.

The prior art of estimate auditing does not address issues relating to identifying included and non-included items in one vendor's estimating system line descriptions using an equivalent line description in another vendor's estimating system.

The prior art of estimate data communications does not address notifying an entity of the diminished value associated with a short sheet or manufacturer's warranty issues.

The prior art of estimate data communications does not address notifying an entity of a short sheet estimate or items in a damage estimate that affect manufacturer's warranty.

The prior art of warranty reporting does not address verifying manufacturer's warranty requirements for individual vehicle repair operations or parts types in damage repair estimates.

### OBJECTS AND ADVANTAGES

It is, therefore, one advantage of the present invention to overcome the deficiencies of the prior art by providing a system and method capable of efficiently and effectively determining whether a particular damage estimate violates manufacturers' repair warranty conditions.

Another advantage of the present invention is to overcome the deficiencies of the prior art by providing a system and method capable of efficiently and effectively determining whether a particular damage estimate is a short sheet.

Another advantage of the present invention is to overcome the deficiencies of the prior art by providing a system and method capable of efficiently and effectively identifying included and non-included operations associated with one estimating system using a damage repair estimate created with a different estimating system.

Another advantage of the present invention is to overcome the deficiencies of the prior art by providing a system and method capable of efficiently and effectively notifying a financing company, lessee, owner or other entity if a particular vehicle will experience reduction of warranty coverage related to a damage repair estimate.

Another advantage of the present invention is to overcome the deficiencies of the prior art by providing a system and method capable of efficiently and effectively notifying a financing company, lessee, owner, or other entity if a damage estimate related to a particular vehicle is a short sheet.

Another advantage of the present invention is to overcome the deficiencies of the prior art by providing a system and method capable of efficiently and effectively adding a plurality of labor operations and/or parts to a damage repair estimate when selecting a single degree of damage pattern for a related damage zone.

Further objects and advantages are displaying information relating to damage repair estimate warranty issues or short sheet issues, and storing information relating to damage repair estimate warranty issues and short sheet issues. Still further objects and advantages will become apparent from a consideration of the ensuing description and drawings.

The above objects and advantages, and other objects and advantages, are achieved by providing methods and systems for generating a damage repair estimate, identifying repair methods or parts types that reduce or void the manufacturer's warranty, identifying short sheeting items, identifying target estimating system included/non-included operations, displaying information, and notifying an entity.

The steps of generating a damage estimate consists of selecting the vehicle make, model, sub-model, year, damage zones and related degrees of damage, retrieving repair item templates consisting of a plurality of repair operations and parts relating to a particular year, make, model, sub-model, damage zone and related degree of damage, retrieving included/non-included operations consisting of a plurality of included/non-included operation relating to repair operations and parts in said repair item template, and generating a displayable damage repair estimate file containing said repair item template records and said included/non-included operations records.

The steps of identifying repair methods or parts types that reduce or void the manufacturer's warranty consists of reading the vehicle make, model, sub-model, year, mileage, and vehicle identification number from a damage estimate, retrieving a warranty template consisting of a plurality of repair operations and parts types associated with a specific year, make, model, sub-model, mileage vehicle, determining if the vehicle is still covered under a manufacturer's warranty, identifying replacement parts and repair operations that violate an associated manufacturer's warranty specifications, and creating a displayable warranty issue file.

The steps of identifying short sheeting items consists of reading estimate line item records from a damage estimate, retrieving a damage zone template consisting of a plurality of estimating system operation descriptions and associated damage zones, determining the damage zones associated with specific record in the estimate, retrieving a repair item template consisting of a plurality of repair operations and parts associated with a specific year, make, model, sub-model and damage zone, identifying repair operations or parts in the associated repair item template but not in the damage estimate, and creating a displayable short sheet issue file.

The steps of identifying target estimating system included/non-included operations consists of reading the operation description lines from a damage estimate, identifying the target estimating system, retrieving a translation table consisting of a plurality of estimating system operation descriptions and associated group code, identifying damage estimate repair lines that match an operation description record in said translation table, retrieving an included/non-included operations table consisting of a plurality of included/non-included operation and associated group code records, identifying records in the included/non-included operations table associated with a particular damage estimate record, retrieving an included operations table consisting of a plurality of included operation and associated group code records, identifying records in the included operations table relating to specific line item record in the damage estimate, and creating a displayable included operations file.

The steps of notifying an entity consists of retrieving the vehicle identification number from the repair estimate, retrieving an entity notification record from a database for the specific vehicle containing contact information such as email address, phone number, name, text message information, creating a notification message, and transmitting said notification message to identified entities.

The steps of displaying information consists of retrieving records from the database for a specific vehicle and displaying, consolidating the records into a report and displaying the report on an electronic viewing device.

### SUMMARY

In accordance with the present invention methods and systems for generating a damage repair estimate, generating information relating to warranty and short sheet issues for a particular damage repair estimate, identifying included/non-included operations in a target damage repair estimate, and notifying entities of the existence of warranty and short sheet issues.

### BRIEF DESCRIPTION OF THE DRAWINGS

FIG. 1 is a schematic representation of the system of the present invention showing the relationship of different entities using the system;

FIG. 2 is a schematic diagram of the computer system of the present invention for generating a damage estimate, determining if a particular damage estimate is subject to warranty reduction, determining if a particular damage estimate is subject to short sheet, identifying included/non-included operations and/or parts in a damage estimate and notifying entities;

FIG. 3 is flow diagram of the method of the present invention showing the steps for determining whether a particular estimate is subject to manufacturer warranty reduction or short sheet issue;

FIG. 4 is a user interface display of an electronically displayable file showing a page for uploading a damage estimate;

FIG. 5 is a flowchart of the method of the present invention showing the steps for determining the included/non-included operations in a line description of a target damage estimating system;

FIG. 6 is a flowchart of the method of the present invention showing the steps for generating a damage estimate with visible and non-visible damage;

FIG. 7 is a user interface display of an electronically displayable file showing a page for generating a damage estimate;

FIG. 8 is a user interface display of an electronically displayable file showing a included/non-included operations and/or parts for a target damage estimating system;

FIG. 9 is a user interface display of an electronically displayable file showing of a report summary with a warranty issue;

FIG. 10 is a user interface display of an electronically displayable file showing of a report summary with a short sheet issue;

FIG. 11 is a user interface display of an electronically displayable file showing a pattern generated damage estimate;

FIG. 12 is a user interface display of an electronically displayable file showing an entity notification;

### DETAILED DESCRIPTION

### One Embodiment

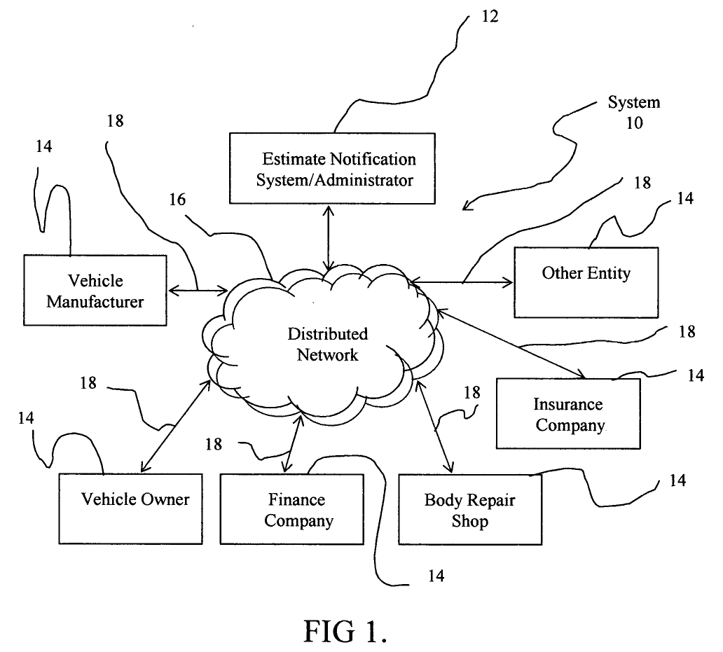

Referring to the drawings, FIG. 1 is a highly schematic diagram of a system, for example in the form of a computer network 10, designed to implement the subject invention. FIG. 1 may also be viewed as showing the relationship of the different entities potentially involved in the application of one embodiment of the present invention. Specifically, a computer implemented damage estimate review notification system 12 exchanges data with a plurality of remote terminals 14 through data transmission across a distributed network 16, e.g. Internet. The terminals 14 represent individual vehicle owners, financial institutions, insurance companies, independent adjusters, loan co-signers, body repair shops, vehicle manufacturers and other entities accessing estimate notification system 12, as discussed more fully herein below, to upload damage estimates, receive notification, obtain estimate analysis results and obtain consolidated management reports.

The distributed network 16 may be any type of communications channel such as a local area network (LAN), wide area network (WAN), direct computer connections, and/or wireless connections using radio frequency, infrared, or other wireless technologies using any appropriate communication hardware and protocols, and may further be the Internet. Thus, terminals 14 may be connected to distributed network 16 by any conventional communication links 18, including hardwired and/or wireless.

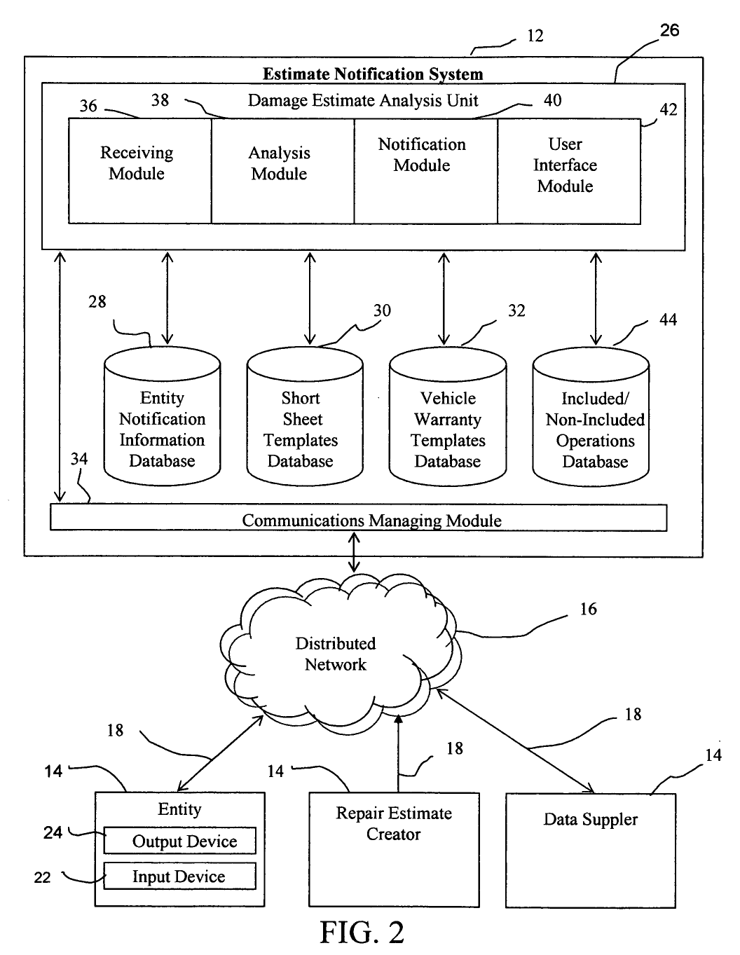

Referring to FIG. 2, in one embodiment, estimate notification system 12 includes a damage estimate analysis unit 26, an entity notification information database 28, a short sheet templates database 30, a vehicle warranty templates database 32, an included/non-included operations database 44, a data communications module 34, all of which are connected together for effective data communication. Damage estimate analysis unit 26 specifically includes a receiving module 36, an analysis module 38, a notification module 40 and a user interface module 42.

It should be noted that the vehicle estimate notification system 12 and the damage estimate analysis unit 40 in accordance with the embodiment of the present invention is illustrated and discussed herein as having various modules and units which perform particular functions. It should be understood that these modules and units, including the file server and databases, are merely schematically illustrated based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Thus, the present invention as schematically embodied in FIG. 2 should not be construed to limit the estimate notification system 12 of the present invention, but be understood to merely be a schematic example.

The short sheet template database 30 contains a comprehensive collection of repair templates, organized, indexed and/or retrievable based on a vehicle year, make, model, sub-model and damage zone. A template is a set of repairs operations and/or replacement parts and their associated labor hours, labor types and parts types. Standardized damage zones are used in the insurance collision repair process to classify areas of damage. Damage zones include right front, left front, right side, rear, rear left, rear right and rollover.

As previously mentioned, the administrator of estimate notification system 12 acquires damage zone template data from a variety of data suppliers 14. Each item of data acquired and entered into damage zone template database 30 is indexed by manufacturer, make, model, sub-model and damage zone. A template consists of all the records for a specified vehicle for a specific damage zone with a specific damage range indicator. For example a template consists of all the records retrieved with an index of “2004”, “FORD”, “F150”, “FRONT BUMPER”.

The vehicle warranty templates database 32 consists of a comprehensive collection of warranty templates, organized, indexed and/or retrievable based on manufacturer, year make model and sub-model. A template is a set of repair operations and/or replacement parts and their associated warranty violating indicator indexed by year, make, model, sub-model and mileage. For example a template consists of all the records for a specified manufacturer make with an index of, “2006”, “GENERAL MOTORS”, “CADILLAC”, ESCALADE”, “XL”.

The included/non-included operations database 44 consists of a comprehensive collection of line descriptions organized, indexed and/or retrievable based on group code. For example fixing a hood is described differently by various estimating system manufacturer's. The common group code 3 indexes the various estimating systems manufacturer's line descriptions of “PANEL,HOOD”, “Hood Outside”, “Hood Panel” and “Hood” to the common group 3.

The included/non-included operations database 44 consists of a comprehensive collection of repair operations and/or parts included/not-included in a line description, organized, indexed and/or retrievable based on group code, estimating system identifier, and repair operation type. For example, included/non-included operations in replacing a hood in a Mitchell damage estimating system consists of all the records with an index of “3”, “YES”, “YES”, “YES”, REPLACE”, where YES define inclusion of an item in a specific estimating systems and can be YES or NO.

The entity notification information database consists of a comprehensive collection of contact information organized, indexed and/or retrievable based on a vehicle identification number. For example contact information consists of all the records retrieved with an index of “4S3BK635XS932008”.

Short sheet template database 30, entity notification information database 28, included/non-included operations database 44 and vehicle warranty templates database 32 may be any conventional database capable of effectively storing collections of records in an organized accessible manner to permit efficient easy access to desired pieces of data, i.e. one or more records, for example, associated with a particular index, using appropriate database management system software.

In one embodiment, a damage estimate analysis unit 26 includes appropriate hardware and software for implementing the various modules and functions necessary to perform the functions of the estimate notification system described herein. Damage estimate analysis unit 26 may be a general purpose computing device with a central processing unit (CPU) or processor. The software of unit 26 and of the various modules within unit 26 resides in a computer readable storage medium in the form of encoded executable instructions for operating the system and performing the functionalities and process steps described herein.

Receiving module 36 functions to receive a estimate file uploaded from a repair facility, insurance office or other source of estimate files. Thus, module 36 includes the appropriate software necessary to import estimate file(s) and organize the uploaded estimate information in a manner appropriate for further data processing. Information extracted and organized from the estimate file consists of the owner information, vehicle identification number, financing company information, insurance company information, repair facility information, estimate line descriptions and replacement parts, damage zones and estimate parts and labor totals.

Analysis module 38 functions to evaluate the uploaded estimate against short sheet templates and/or included/non-included operations and/or vehicle warranty templates. Analysis of short sheeting consist of segmenting the estimate into sets of operations associated with specific damage zones, retrieving a specific template associated with a specific damage zone from the short sheet templates database 30, evaluating a specific set of operations against a specific damage zone template to identify significant omissions of repair operations, totaling labor hours and replacement parts costs, and generating the omitted repair content section of the damage estimate analysis.

Analysis of vehicle warranty consist of evaluating the estimate against a specific warranty template associated with the estimate year, make, model, and sub-model. Analysis of warranty consists of evaluating a specific estimate's operations and replacement parts types against a specific warranty template associated from the vehicle warranty templates damage 32, identifying specific parts replacement parts that significantly reduce the warranty associated with the estimate, identifying specific labor operations that significantly reduce the warranty associated with the estimate, and generating the warranty section of the damage estimate analysis.

Analysis of included/non-included operations consist of evaluating the estimate against specific records associated with the damage estimating system manufacturer and line description. Analysis of included/non-included operations consists of evaluating a specific damage estimate's line description against records associated from the included/non-included operations database 44, identifying specific included and non-included operations associated with specific estimate line descriptions and generating the included/non-included operations section of the damage estimate analysis.

Importantly, damage estimate analysis unit 26 includes analysis module 38 which is adapted to execute particular process steps including analyzing short sheet conditions, analyzing included/non-included operations, analyzing vehicle warranty conditions and following specific logic to ultimately form conclusions relative whether a particular estimate has warranty or short sheet issues and identifying included/non-included operations and parts associated with a target estimating system. As used herein, a warranty or short sheet issue preferably refers to the issue of whether a particular estimate has significant warranty reduction or significant omitted line descriptions. Examples of significant warranty reduction are, if a new vehicle used aftermarket crash parts and the manufacturer's warranty was voided on the aftermarket part and on any adjacent parts of the vehicle, or if a structural aluminum component was heated and pulled voiding of the vehicle manufacturer's warranty. An examples of significant short sheet is an estimate for collision damage to the front of a vehicle that only consists of damage visible to the eye and does not include line descriptions for repairing damage under a bumper cover.

Notification module 40 functions to retrieve information from the entity notification information database 28 and create an electronic message packet consisting of a notification message and damage estimate analysis for entities associated with the vehicle identification number in the estimate. Based on the conclusions of the analysis module 38, notification module 40 initiates the delivery of an email or other appropriate notification method to entities identified to the availability of the damage estimate analysis.

User interface module 42 is adapted to utilize the information provided by analysis module 38 to generate a user interface for delivery to output device 24 of terminal 14. User interface module 42 may be in the form of a file server with appropriate software capable of generating particular electronically displayable files for delivery to, and display by, output device 24 of terminal 14. Alternatively, the electronically displayable files may be stored in a separate file server within estimate notification system 12 or may reside on a remote server to which the estimate notification system 12 is connected. Communications managing module 34 is adapted to manage communications and interactions between estimate notification system 12 and its various components, and with the various terminals 14 via the distributed network 16.

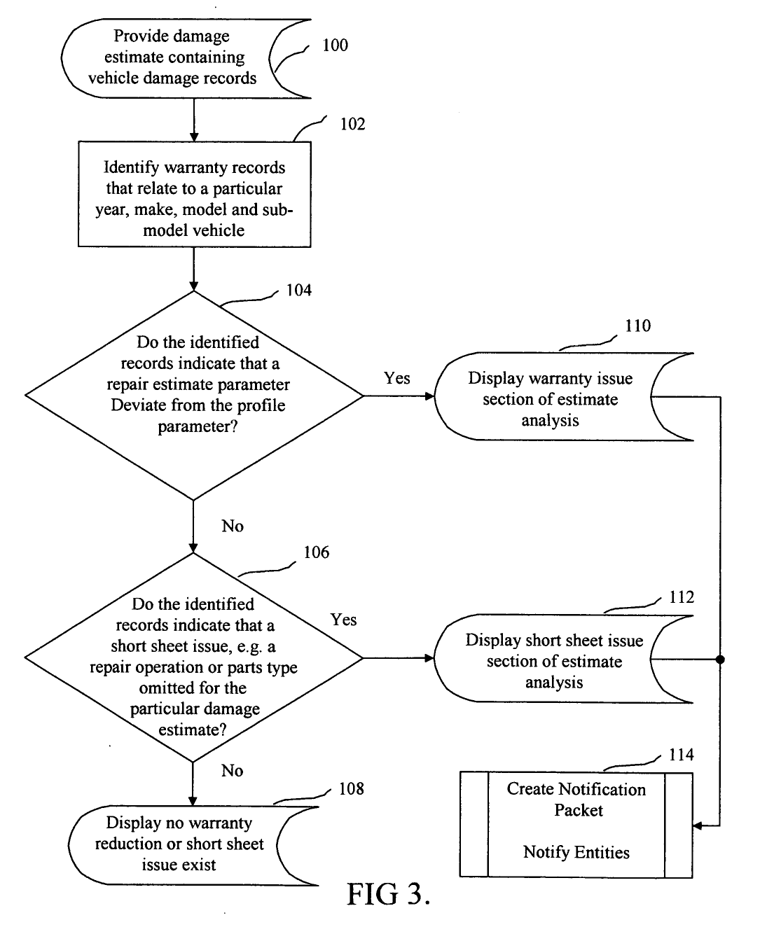

Referring to FIG. 3, a general representation of one method for warranty issue and short sheet analysis, corresponding to the system of the present invention of FIG. 2, is illustrated in the form of a flow diagram starting with step 100 in which vehicle warranty templates database 32, short sheet templates database 30, and entity notification information database 28, containing templates and entity notification information, is provided by, for example, the loss notification system administrator.

Next, in step 102, receiving module 36 receives and extracts notification information and repair information from a damage estimate file. Typically, step 102 is performed in response to an estimate being uploaded by a repair estimate creator 18 to estimate notification system 12. Specifically manufacturer's line descriptions, repair operations, parts types, labor hours and damage zones are extracted from the damage estimate and temporarily stored. In addition, owner, insurance company and financial institution information consisting of the insurance company name, claim id, insured policy number and repair estimate creator information is extracted from estimate files and temporarily stored. In addition, vehicle information consisting of the vehicle identification number, year, make, model, sub-model and mileage are extracted from estimate files and temporarily stored. In one embodiment, an estimate is uploaded to a website permitting simple, automated communication between the repair estimate creator 18 and system 12 via distributed network 16.

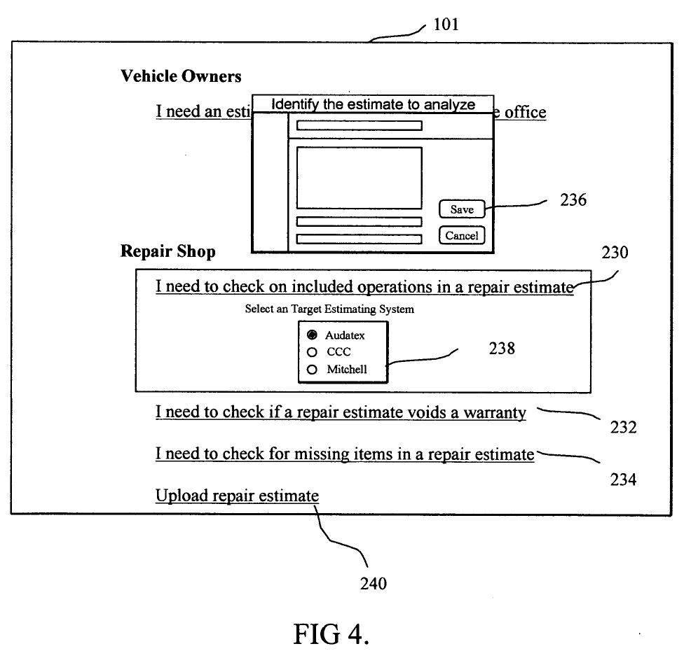

For example, as shown in FIG. 4, an electronically displayable file including a user interface 101, in the form of an output screen, is displayed on the output device 24 of the customer's terminal 14. The repair estimate creator 14 selects the analysis to perform using “I need to check on included operations in a repair estimate” hyperlink 230, “I need to check if a repair estimate voids a warranty” hyperlink 240 or “I need to check for missing items in a repair estimate” hyperlink 250. If the repair estimator creator 14 selects I need to check on included operations in a repair estimate 230 the target estimating system manufacturer is identified using option group 238. Then, the repair estimate creator browses for the damage estimate file to upload and selects “Save” button 236. Then, the repair estimate creator initiates the estimate analysis using “Upload repair estimate” hyperlink 240.

The upload request is received by system 12 via communications managing module 34, which processes the request utilizing damage estimate analysis unit 26. Specifically, analysis module 38 processes the request by selecting all records in short sheet templates database 30, vehicle warranty templates 32, and included/non-included operations database 44 relating to a particular year, make, model, sub-model or target estimating system as represented by step 102 of FIG. 3. Of course, other files may be displayed to the user for inputting contact information, payment information or other information to allow appropriate processing.

Next, in step 104, analysis module 38 determines whether the vehicle in the damage estimate is covered under warranty. Specifically a vehicle is under warranty if it is newer than the number of years in the warranty template and the vehicle mileage is less than the mileage in the warranty template specified by the manufacturer. If the vehicle is under manufacturer's warranty analysis module 38 determines whether a warranty issue exists. Specifically, a warranty issue exists if a warranty template record is found in warranty template database 32 which indicates, for example, that an aftermarket part was found in the damage estimate or a specific repair operation was found in the damage estimate, for example heating and pulling a structural aluminum component that reduce or void the manufacturer's warranty associated with the vehicle specified in the damage estimate. If a warranty condition exists analysis module 38 create a displayable warranty issue file for the specific vehicle in the damage estimate. If a warranty issue does not exist analysis module 38 creates a displayable file indicating that no warranty issue exists for the particular vehicle in the damage estimate.

Next, in step 106, analysis module 38 determines whether the identified records relating to a particular damage estimate indicates a short sheet, i.e., a repair operation or part is included in the template but is not in the damage estimate for specific damage zones of the particular vehicle. Specifically, a short sheet exists if a short sheet template record is found in short sheet database 30 which indicates, for example, that repairing a bumper reinforcement was found in the short sheet template but not the damage estimate for a front bumper replacement.

Next, in step 108 if no warranty issue exist user interface module 42 initiates a command for the display of an electronically displayable file indicating that no warranty issues exists for the particular vehicle from system 12, or a file server on the distributed network 16, to terminal 14 for display on output device 24.

Next, in step 108 if no short sheet issue exist user interface module 42 initiates a command for the display of an electronically displayable file indicating that no short sheet issues exists for the particular vehicle from system 12, or a file server on the distributed network 16, to terminal 14 for display on output device 24.

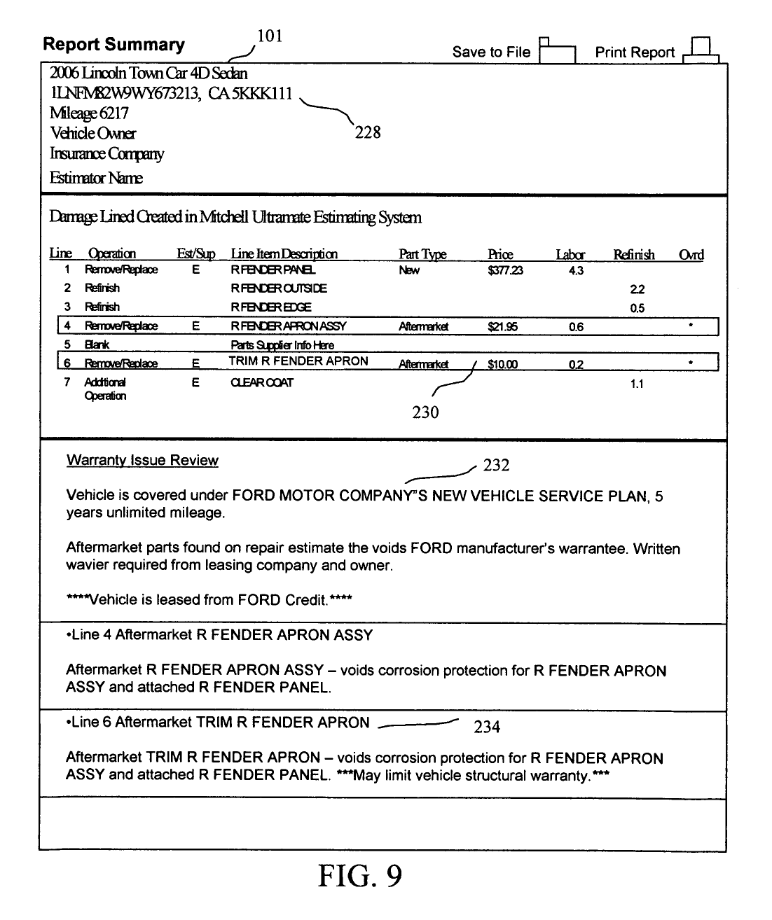

Next, in step 110 if a warranty issue exist analysis module 42 initiates a command for the storage of a displayable warranty issue file for the particular damage estimate then user interface module 42 initiates the transmission of a warranty issue file from system 12, or a file server on the distributed network 16, to customer terminal 14 for display on output device 24. For example, referring to FIG. 9, an electronically displayable file in the form of a user interface 101 showing a report summary may include vehicle, customer and insurance information 228, damage estimate line descriptions related to warranty issues 230, manufacturers warranty requirements 232 and warranty issues 234.

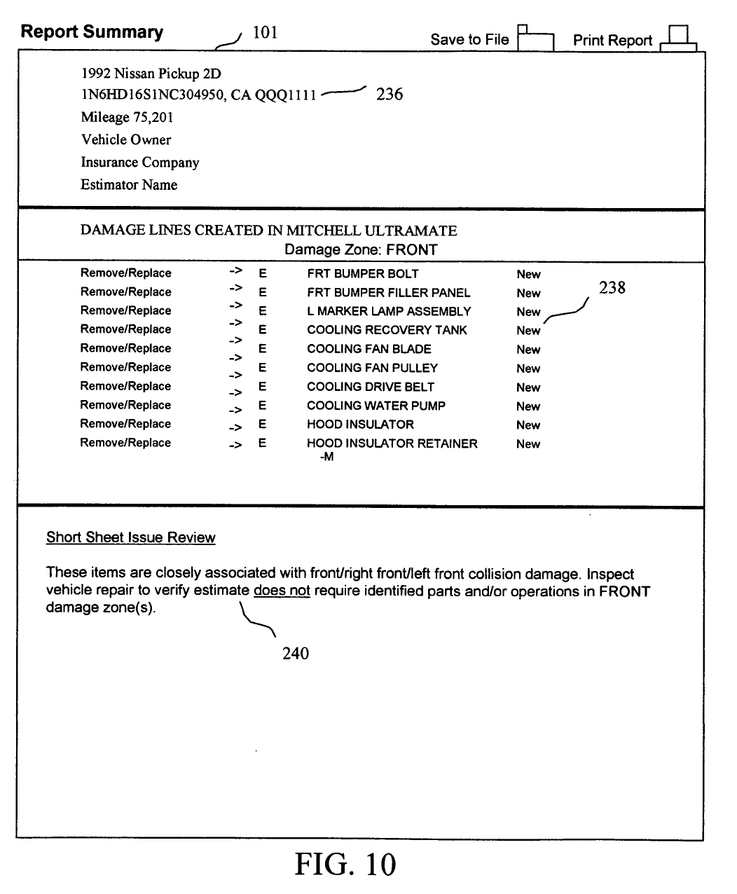

Next, in step 112 if a short sheet issue exist analysis module 42 initiates a command for the storage of a displayable warranty issue file for the particular damage estimate then user interface module 42 initiates the transmission of a warranty issue file from system 12, or a file server on the distributed network 16, to customer terminal 14 for display on output device 24. For example, referring to FIG. 10, an electronically displayable file in the form of a user interface 101 showing a report summary may include vehicle, customer and insurance information 236, repair operations and/or parts identified in the short sheet template and not found in the damage estimate 238 and short sheet review 240.

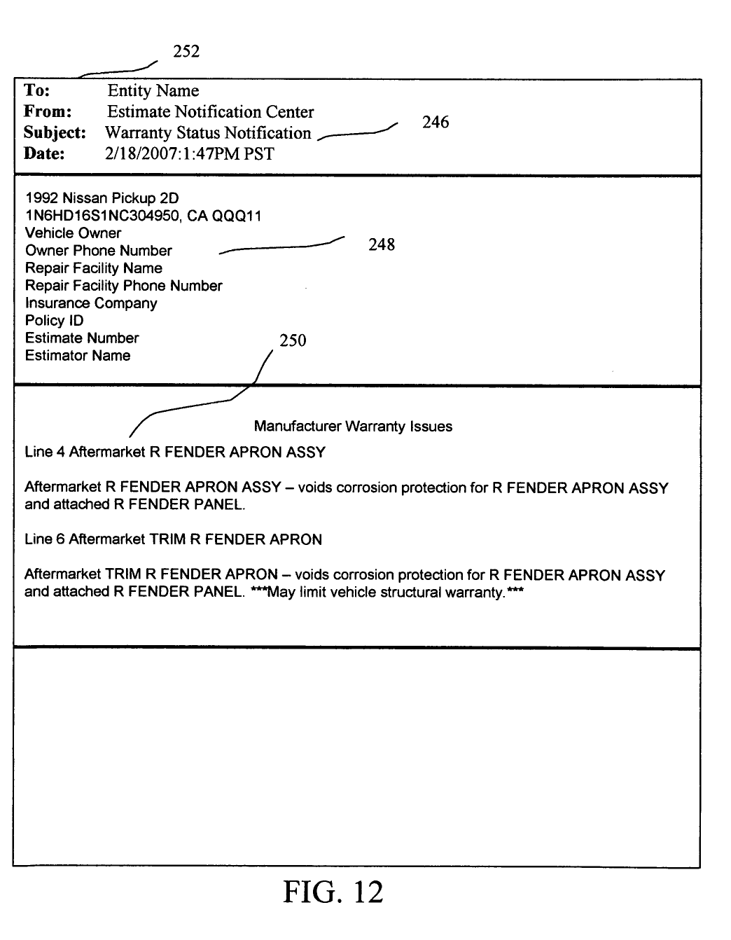

Next, in step 114 if a warranty or short sheet file exist notification module 40 identifies records in entity notification database 28 associated with entities to contact with information associated with the existence of warranty or short sheet issues for a particular vehicle, creates notification packages for particular entities and initiates transmission of notification packages from system 12, or on a file server on the distributed network 16 to entities via electronic mail or other electronic communications methods. For example, referring to FIG. 12, an electronically displayable file in the form of an electronic mail 252 showing information related to the entity notified 246, information related to the vehicle, estimate creator and insurance company 248 and a summary of warranty and/or short sheet issues 250.

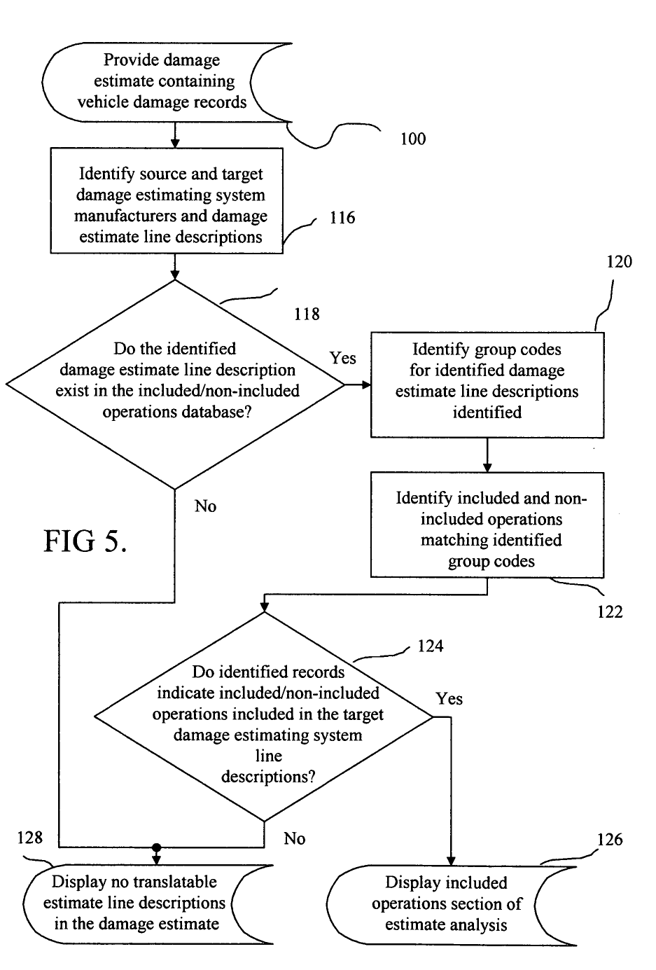

Referring to FIG. 5, a general representation of one method for identifying and displaying included repair operations information relating to a target manufacturer's line descriptions in a damage estimate, corresponding to the system of the present invention of FIG. 2, is illustrated in the form of a flow diagram starting with step 100 in which included/non-included operations database 44 and entity notification information database 28, containing included/non-included operations and/or parts information and entity notification information, is provided by, for example, the loss notification system administrator.

Next, in step 116, receiving module 36 receives and extracts repair information from a damage estimate file. Typically, step 116 is performed in response to an estimate being uploaded by a repair estimate creator 18 to estimate notification system 12. Specifically manufacturer's line descriptions, line number and repair operations from the damage estimate are extracted and temporarily stored. In addition, vehicle information consisting of the vehicle identification number, year, make, model, sub-model and mileage are extracted from estimate files and temporarily stored. In addition, the manufacturer of the target damage estimating system used to create the damage estimate is extracted from the estimate files and temporarily stored. In one embodiment, an estimate is uploaded to a website permitting simple, automated communication between the repair estimate creator 18 and system 12 via distributed network 16.

Next, in step 118, analysis module 38 determines whether the identified records relating to a particular target damage estimating system's line descriptions in a particular damage estimate exist in included/non-included operations database 44. Specifically, a manufacturer's line description exists if a manufacturer's line description is found in included/non-included operations database 44.

Next, in step 120 analysis module 38 identifies group codes related to particular manufacturer's line descriptions in a particular damage estimate. Specifically, analysis module 38 accesses included/non-included operations database 44 and identifies the group code related to particular source manufacturer's line descriptions.

Next, in step 122 analysis module 38 identifies included/non-included operations and/or parts related to identified group codes. Specifically, analysis module 38 accesses included/non-included operations database 44, identifies records matching identified group codes, identifies included/non-included operations and/or parts related to identified group codes and determines if identified included/non-included operations and/or parts are included in a particular target manufacturer's damage estimating system line description. An included/non-included operations and/or parts is included in a particular target damage estimating system if the field in the record identifying inclusion of a particular included/non-included operations and/or parts related to a particular target damage estimating system is set to “YES”.

Next, in step 124, analysis module 38 determines whether included/non-included operations and/or parts exist for a particular damage estimate. Specifically, analysis module 38 determines if any records identifying included/non-included operations and/or parts related to a particular target manufacturer's line descriptions exist.

Next, in step 126 if no included/non-included operations and/or parts exist user interface module 42 initiates a command for the display of an electronically displayable file indicating that no included/non-included operations and/or parts exists for the particular damage estimate from system 12, or a file server on the distributed network 16, to terminal 14 for display on output device 24.

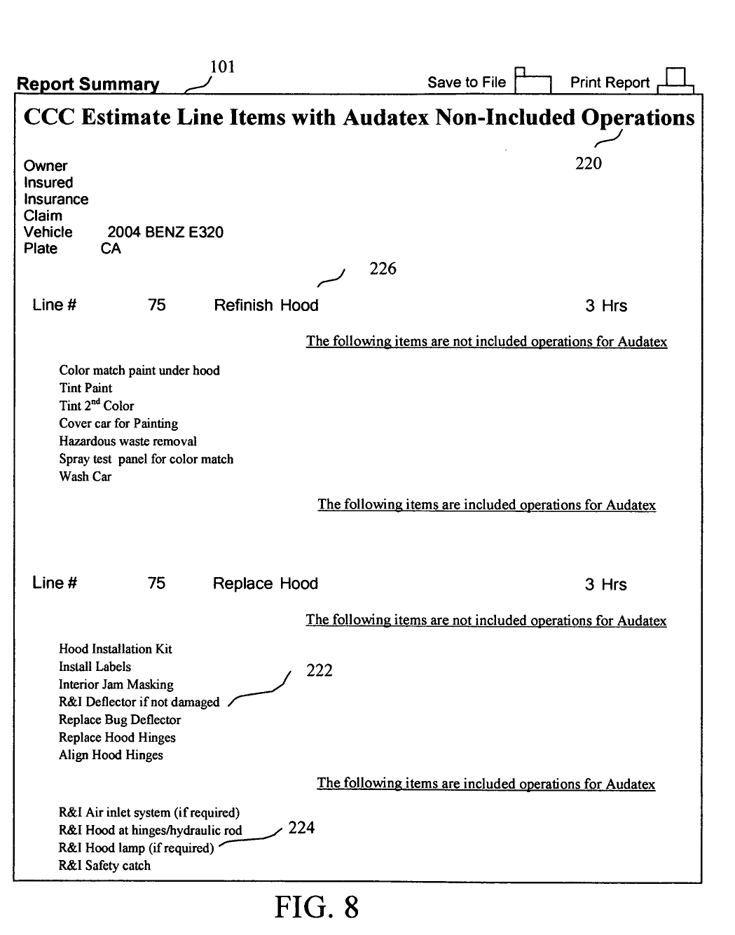

Next, in step 128 if included/non-included operations and/or parts exist analysis module 42 initiates a command for the storage of a displayable included operations file for the particular damage estimate then user interface module 42 initiates the transmission of a included operations file from system 12, or a file server on the distributed network 16, to customer terminal 14 for display on output device 24. For example, referring to FIG. 8, an electronically displayable file in the form of a user interface 101 showing a report summary may include identification of the source and target damage estimating systems 220, damage estimate line descriptions 226, repair operations and/or parts not included in target estimating systems line descriptions 222 and repair operations and/or parts included in target damage estimating systems line descriptions 224.

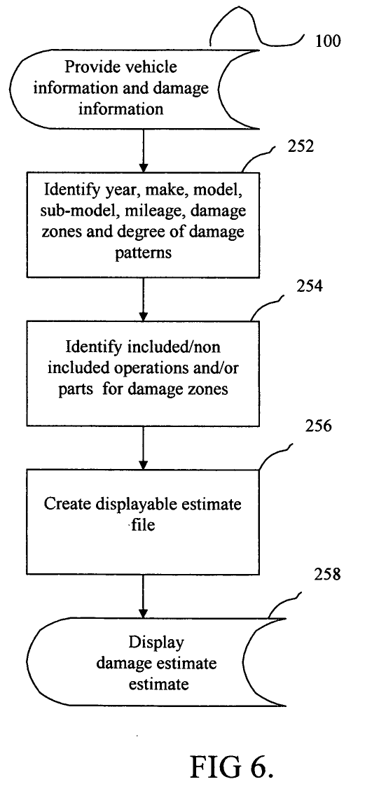

Referring to FIG. 6, a general representation of one method for generating a damage estimate, corresponding to the system of the present invention of FIG. 2, is illustrated in the form of a flow diagram starting with step 100 in which included/non-included operations database 44 and short sheet templates database 30, containing included/non-included operations and/or parts information and damage zones and degrees of damage, is provided by, for example, the loss notification system administrator.

Next, in step 128, receiving module 36 receives information relating to vehicle year, make, model, sub-model, mileage, related damage zones and related degrees of damage for a particular vehicle. Typically, step 128 is performed in response to a customer, i.e. individual consumer, providing the information of a particular vehicle to vehicle estimate notification system 12. In one embodiment, the customer accesses a website containing electronically displayable files having user interfaces for permitting simple, automated communication between the customer and system 12 via distributed network 16.

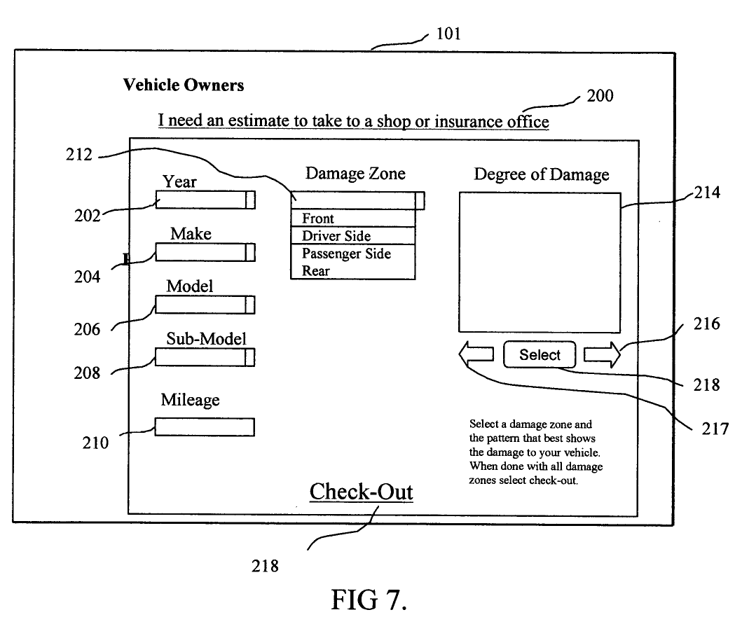

For example, as shown in FIG. 7, an electronically displayable file including a user interface 101, in the form of an output screen, is displayed on the output device 24 of the entity terminal 14. The user interface is utilized by customers to upload vehicle and damage information to estimate notification system 12 via distributed network 16. customer 14 select “I need an estimate to take to a shop or insurance office” hyperlink 200 and begins creating a damage estimate selecting the vehicle year in an input field 202, vehicle make in an input field 204, vehicle model in an input field 206, vehicle sub-model an input field down 208 and entering the vehicle mileage in an input field 210. The customer then identifies damage zones by selecting damage areas in an input field 212 related to the particular vehicle and views patterns representing damage for the related damage zone in display field 214. The customer then scrolls through patterns related to degrees of damage for the related damage zone using navigation button 216 and navigation button 217. The customer then selects the pattern most closely matching the degree of damage and damage area selecting button 218. The customer then selects “Check-Out” hyperlink 218 to submit vehicle information and degrees of damage related to damage zones to system 12 for processing. Specifically, analysis module 36 processes the request by selecting all records in short sheet templates database 30 related to degrees of damage and related damage zones of a particular vehicle.

Next, in step 130, analysis module 38 determines whether included/non-included operations and/or parts exist for a particular damage estimate. Specifically, analysis module 38 determines if any records identifying included/non-included operations and/or parts related to a particular damage line descriptions exist.

Next, in step 132 analysis module 38 creates a displayable estimate file for the particular damage zones, related degrees of damage for the particular vehicle.

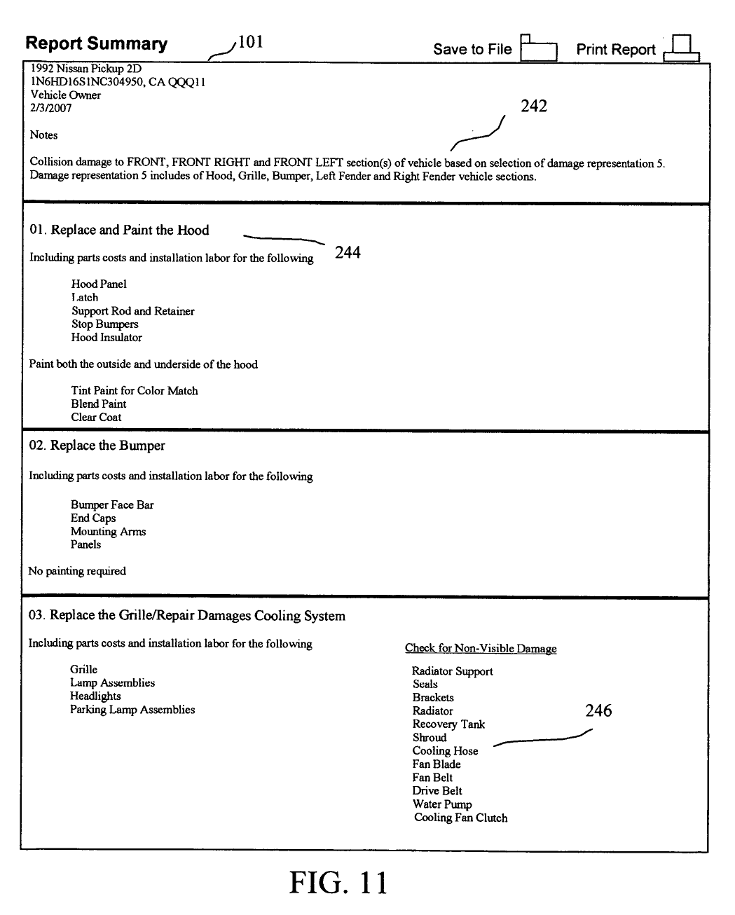

Next, in step user interface module 42 initiates a command for the display of an electronically displayable estimate file from system 12, or a file server on the distributed network 16, to terminal 14 for display on output device 24. For example, referring to FIG. 11, an electronically displayable file in the form of a user interface 101 showing a report summary may include summary information related to damage zones and related damage patterns selected 242, identified template repairs 244 including all operations and/or parts related to damage zones and degrees of damage and identification of operations and/or parts related to damage zones that are not visible o the exterior of the particular vehicle.

What is claimed is:

1. A method for generating information relating to warranty conditions relating to repair operations or parts types in a damage estimate, comprising the steps of: receiving a damage estimate that relates to a particular vehicle; identifying records in a database that relate to the particular vehicle, said records containing data relating to parts types and repair operations that reduce or void the manufacturer's warranty, said database having records of vehicles manufactured by a plurality of manufacturers; determining whether said damage estimate contains repair operations or parts types contained in said database indicating that a warranty issue exists; and if a warranty issue exists then creating an electronically displayable warranty issue file.

2. The method of claim 1, further including displaying an electronically displayable warranty issue file for the particular damage estimate.

3. The method of claim 1, wherein the warranty issue file includes sufficient information to identify the particular vehicle and information relating to parts or repair operations identified in said damage repair estimate that reduce or void the manufacturer's warranty.

4. The method of claim 1, further including the steps of identifying records in a database relating to entities to notify when a warranty issue file exists for a particular vehicle, said records containing contact information relating to particular entities; creating a notification packet containing information relating to said warranty issue file; and electronically sending said notification packet to said entities.

5. A method for generating information relating to repair operations and parts omitted from a damage estimate, comprising the steps of: receiving a damage estimate relating to a particular vehicle; identifying at least one damage zone in said damage estimate; identifying records in a database relating to said damage zone, said records containing data relating to repair operations and parts in a plurality of damage zones, said database having records for a plurality of damage zones; determining whether said damage estimate omits repair operations or parts contained in said records indicating that a short sheet issue exists; and if a short sheet issue exists then creating an electronically displayable short sheet issue file.

6. The method of claim 5 further including displaying an electronically displayable short sheet file for the particular damage estimate.

7. The method of claim 5, wherein the short sheet file includes sufficient information to identify the particular vehicle and information relating to parts and repair operations omitted in said damage estimate.

8. The method of claim 5, further including the steps of identifying records in a database relating to entities to notify when a short sheet file exists for a particular vehicle, said records containing contact information relating to particular entities; creating a notification packet containing information relating to said short sheet file; and electronically sending said notification packet to said entities.

9. A method for generating information relating to repair operations and parts included in a target estimating system's line descriptions comprising the steps of: receiving a source damage repair estimate; identifying the target damage estimating system manufacturer; identifying records in a database relating to a particular source damage repair estimate, said database containing information relating to identifying damage estimating system's line descriptions that substantially describe similar repair operations, and containing information identifying included operations and parts relating to a particular damage estimating system's line description, said database having a plurality of damage estimating system line descriptions, included operations and parts by a plurality of damage estimating system manufacturers; identifying target damage estimating system line descriptions substantially similar to source damage estimating system line descriptions contained in said database; identifying included operations and parts relating to target estimating system line descriptions contained in said database; and creating an electronically displayable included operations file.

10. The method of claim 9 further including displaying an electronically displayable included operations file for the particular damage estimate.

11. The method of claim 9, wherein the included operations file includes sufficient information to identify the particular vehicle and information relating to parts and repair operations identified in said target manufacturer's damage repair estimate line descriptions.

12. A computer system for generating information relating to warranty conditions relating to repair operations or parts types in a damage estimate, including: a receiving module used to receive a damage estimate; an analysis module coupled to vehicle warranty templates database used to identify repair operations or parts that reduce a manufacturer's warranty in a particular damage estimate and to create an electronically viewable warranty issue file; a vehicle warranty templates database used to store a plurality of records relating to repair operations and parts that reduce or void a manufacture's warranty; and a user interface module adapted to receive a user request for information related to one or more damage estimates.

13. The system of claim 12, further including an entity notification information database used to store information related to entities to notify of the existence of a warranty issue file; and an entity notification information module coupled to the entity notification information database used to electronically notify entities of the existence of a warranty issue file for a particular damage estimate.

14. A computer system for generating information relating to repair operations and parts omitted from a damage estimate, including: a receiving module used to receive a damage estimate; an analysis module coupled to short sheet templates database used to identify repair operations or parts omitted from a particular damage estimate and to create an electronically viewable short sheet file; a short sheet templates database used to store a plurality of records identifying damage zones and data relating to repair operations and parts associated with repairing damage zones; and a user interface module adapted to receive a user request for information related to one or more damage estimates.

15. The system of claim 14, wherein the included short sheet file includes sufficient information to identify the particular vehicle and a description of parts types and/or repair operations omitted in a particular damage estimate.

16. The system of claim 14, further including an entity notification information database used to store information related to entities to notify of the existence of a short sheet file; and an entity notification information module coupled to the entity notification information database used to electronically notify entities of the existence of a short sheet file for a particular damage estimate.

17. A computer system for generating information relating to repair operations and parts included in a target estimating system's line descriptions, including a receiving module used to receive a damage estimate; an analysis module coupled to an included and/non-included operations database used to identify repair operations and parts included in specific damage estimate line descriptions and to create an electronically viewable included operations file; an included and non-included operations database used to store a plurality of records identifying repair operations included in a manufacturer's line description; and a user interface module adapted to receive a user request for information related to a particular damage estimate.

18. A method for creating a damage estimate, comprising: identifying damage zones relating to a particular vehicle; identifying degrees of damage relating to particular damage zones; identifying records in a database that relate to the particular vehicle, damage zones and degrees of damage, said records containing data relating to repair operations and parts included in said damage zones, said records containing data relating to identifying repair operations and parts relating to damage zones and degrees of damage, said database having records of repair operations and parts for a plurality of vehicles; creating an electronically displayable damage estimate file; and displaying an electronically displayable damage estimate file for the particular vehicle

19. The method of claim 18, wherein the damage estimate file includes information to identify the particular vehicle and substantially identify parts and repair operations related to repairing damage related to said damage zones and said damage degrees.

20. A computer system for creating a damage estimate, including a user interface adapted to enter vehicle information, identify degrees of damage patterns relating to damage areas and display an electronically displayable damage estimate file; an analysis module used to identify short sheet templates relating to a damage zone patterns; a short sheet database used to identifying data relating to repair operations and parts associated with repairing damage zones; and an included and non included operations database used to identify repair operations and parts not included in line descriptions.
